(19) United States
(12) Patent Application Publication
(10) Pub. No.: US 2017/0116174 A1
(43) Pub. Date: Apr. 27, 2017

(54) ELECTRONIC WORD IDENTIFICATION TECHNIQUES BASED ON INPUT CONTEXT

(71) Applicant: Lenovo (Singapore) Pte. Ltd., Singapore (SG)

(72) Inventors: Nathan J. Peterson, Durham, NC (US); Arnold S. Weksler, Raleigh, NC (US); John Carl Mese, Cary, NC (US); Russell Speight VanBlon, Raleigh, NC (US)

(21) Appl. No.: 14/924,091

(22) Filed: Oct. 27, 2015

(51) Int. Cl. G06F 17/27; G06F 17/24; G06F 3/16

(52) U.S. Cl. CPC G06F 17/276; G06F 17/2765; G06F 3/167; G06F 17/24

(57) ABSTRACT

One embodiment provides a method, including: receiving, at an input device of an electronic device, a user input; accessing, using a processor, prior user inputs to the input device; accessing, using a processor, contextual data; and identifying, using a processor, one or more words within the user input based on the contextual data. Other aspects are described and claimed.

### BACKGROUND

Electronic devices such as laptops, tablets, smart phones, etc., accept user inputs, e.g., at physical keyboards, soft keyboards or on-screen keyboards, microphones/speech processing systems, etc. Users provide inputs to control the device as well as to enter data, e.g., into a communication application such as email, SMS text messaging, instant messaging, etc.

As part of the input processing, current devices attempt to identify (including correct and predict) the words being input, e.g., based on a complete or partial input (such as correcting a misspelled word or predicting an input word based on the first letter input by the user). For example, an on-screen keyboard may attempt to predict a word based on the first letter pressed or touched by the user, e.g., based on the user's past inputs starting with that letter. As another example, a speech processing system may attempt to identify a word after it has been spoken by a user, e.g., by accessing a common or even user-specific dictionary of words.

### BRIEF SUMMARY

In summary, one aspect provides a method, comprising: receiving, at an input device of an electronic device, a user input; accessing, using a processor, prior user inputs to the input device; accessing, using a processor, contextual data; and identifying, using a processor, one or more words within the user input based on the contextual data.

Another aspect provides an electronic device, comprising: an input device; a processor operatively coupled to the input device; and a memory device comprising instructions executable by the processor to: receive, at the input device, a user input; access prior user inputs to the input device; access contextual data; and identify one or more words within the user input based on the contextual data.

A further aspect provides a product, comprising: a storage device having code stored therewith, the code being executable by a processor and comprising: code that receives a user input; code that accesses prior user inputs to the input device; code that accesses contextual data; and code that identifies one or more words within the user input based on the contextual data.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example of electronic word identification based on input context.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Current devices employ only a limited variety of identification techniques (including prediction techniques and correction techniques) for handling user inputs. These are essentially limited to accessing common or user specific dictionaries and/or accessing past user inputs in an effort to identify a word.

Although there is continued interest in new ways of making text and audio input recognition better, smarter and faster, input identification techniques continue to rely on the above mentioned approaches, making them error prone. Using a history of prior inputs, e.g., past word combinations, in connection with a basic dictionary look up tends to miss entirely the context in which the user input is provided.

Accordingly, an embodiment provides for improved input identification, and thus improved prediction, correction, etc., by accessing and using contextual data. In an embodiment, the contextual data is accessed in order to improve or adjust a ranking given to candidate words. For example, an embodiment may access contextual data derived from an image, a location, prior communications, etc., in order to leverage this data in ranking candidate words. By way of specific example, if the user had recently searched for and viewed soccer ball images on the device, and then began to enter the letter “s” to the on-screen keyboard in a messaging application, the word “soccer” may be rank higher than ordinary or conventionally identified words (e.g., based on a dictionary lookup and consultation of the user's past entries into the on screen keyboard).

The contextual data may include timing information as well. By way of example, if a user had searched for and viewed images of soccer balls earlier in the day, but had also searched for and viewed images of saxophones a week ago, the candidate word “soccer” may still be ranked higher than “saxophone,” even though both are included in the contextual data.

The illustrated example embodiments will be best understood by reference to the figures. The following description is intended only by way of example, and simply illustrates certain example embodiments.

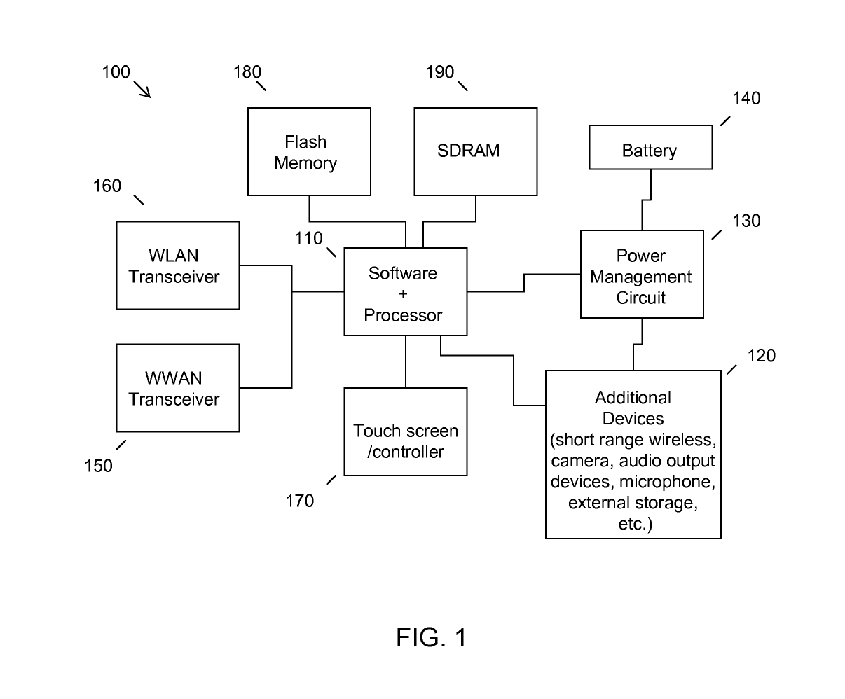

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a wireless wide area network (WWAN) transceiver 150 and a wireless local area network (WLAN) transceiver 160 for connecting to various networks, such as telecommunications networks (WAN) and wireless Internet devices, e.g., access points offering a Wi-Fi® connection. Additionally, devices 120 are commonly included, e.g., short range wireless communication devices, a near field communication device, audio devices such as a microphone, etc., as further described herein. System 100 often includes a touch screen 170 for data input and display/rendering. System 100 also typically includes various memory devices, for example flash memory 180 and SDRAM 190.

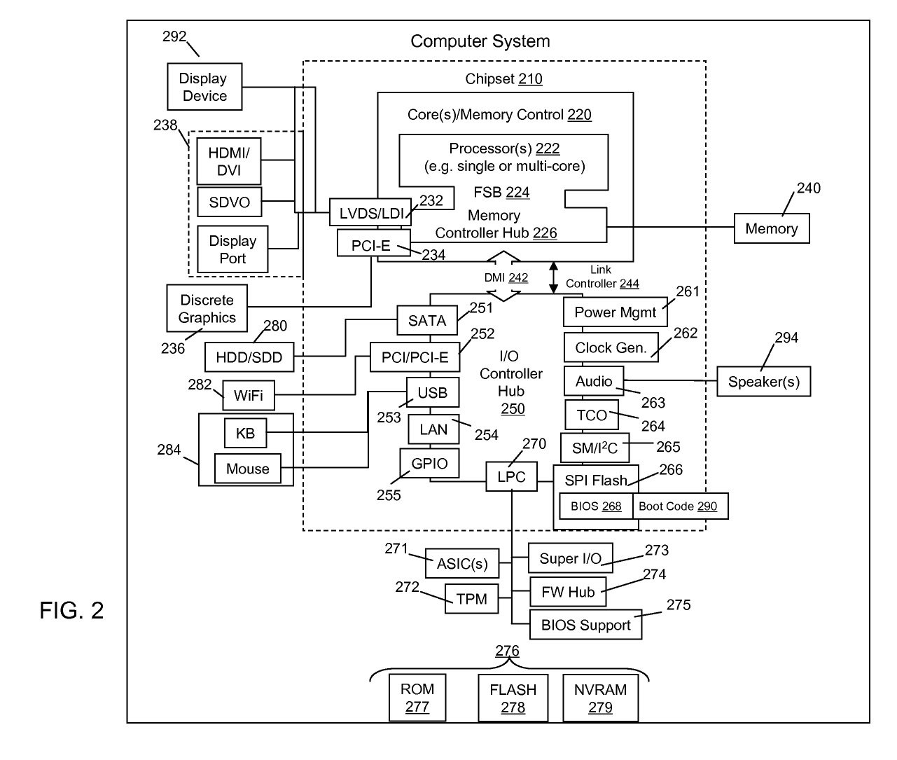

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, and personal computer devices generally. Such devices offer input devices, e.g., on-screen keyboards, microphones and the like. A user may provide inputs to such input devices in connection with controlling applications of the device and for providing communication data, e.g., message data that is to be sent to other devices.

An embodiment improves the processing of the user input such that word(s) are more faithfully identified. As will become apparent from this description, the various embodiments also promote increased speed in terms of identifying the correct word(s) the user is attempting to input more quickly, materially improving the performance of the device in terms of input processing.

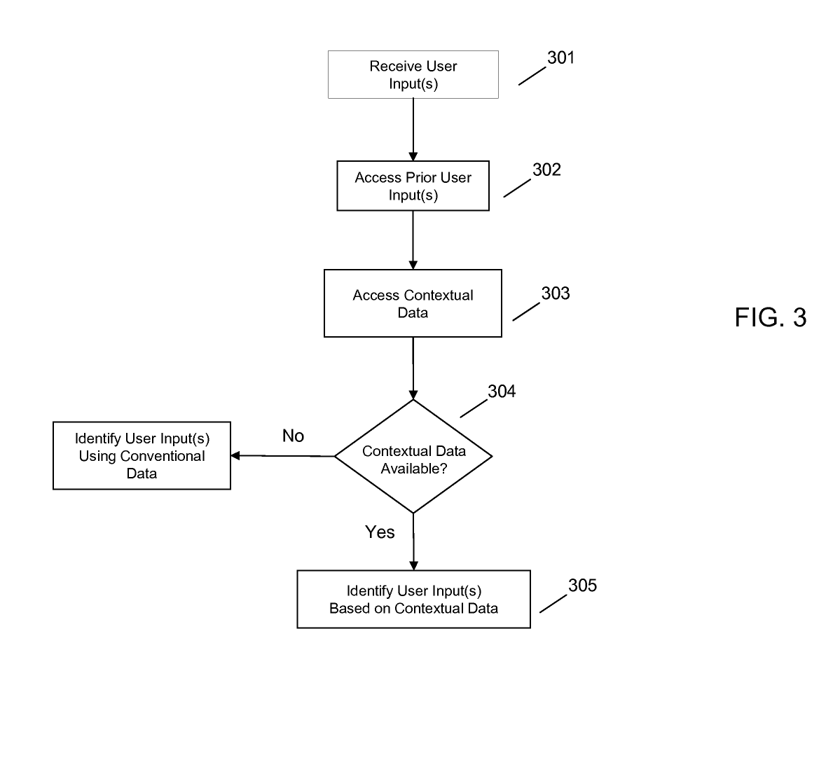

Referring now to FIG. 3, an embodiment provides a method of word identification based on input context. As shown, a user input is received at an input device of an electronic device at 301, e.g., a user touch to a soft keyboard, a user voice input to a microphone and speech processing subsystem, etc. An embodiment may access conventional data in an effort to identify the user inputs, e.g., accessing prior user inputs to the input device at 302. This permits, as described herein, a certain degree of accuracy in identifying the word(s) in the user input. For example, by accessing a prior history of the user's inputs to an on-screen keyboard it is possible to predict a word based on the first letter input. However, this prediction is often wrong because it is heavily biased based on the prior inputs, which may have nothing to do with the current input context.

Thus, an embodiment also accesses contextual data at 303 in an effort to improve the identification process. For example, an embodiment may access contextual data derived from images, location, previous or concurrent textual communications, etc., at 303.

By way of specific example, if the user is making a comment about a photo that they are posting or attaching to a message, data regarding the image is available and may be stored and accessed as contextual data. In this example, if the image were subjected to image recognition processing (either concurrently with the identification process or previously), the resulting metadata of the image recognition processing (or other metadata, e.g., a file name, words included in a URL used to retrieve the image, etc.) may assist in identifying what word(s) are to be prioritized when trying to match the user's input to dictionary words. Thus, if a user were to input “Look at this ‘s’”, with “s” being a partial input at 301, and if the user had not previously entered “soccer ball,” as determined at 302, yet if a soccer ball is in a photo being attached to the message being composed, as determined at 303, a word recognition or prediction may be given that includes the word “soccer” or the phrase “soccer ball” after the user entered “s” or “so” or the like.

The contextual data accessed at 303 may include data derived from a location based resource, e.g., a map service that identifies places near to the electronic device, e.g., based on GPS coordinates. By way of specific example, a user input at 301 of “I'm just sitting at”, where “at” is not yet followed by any input, may be auto-completed (or suggested) as “local ball field”, where the proposed message is “I'm just sitting at local ball field” based on contextual data identifying that the user's electronic device is at or proximate to “local ball field.”

Similarly, the contextual data accessed at 303 may include textual data of an object, such as a web page, word processing file, email, etc., associated with the input. By way of specific example, if a user is sending a web link and a comment about the web link, information about the web link, e.g., key words extracted from the URL, from the actual web page content, etc., may be used in order to perform better word prediction. Thus, if a user has copied a link to “www [dot] website [dot] com”, pasted the link into a messaging application, and begun to input “Look at this w”, where “w” is a partial input, an embodiment may prioritize the word “website” by virtue of the fact that a URL (generally) had been included in the message, or may further promote the word “website” by virtue of the fact that the literal word “website” is included in the URL text. Likewise, processing of the actual content of the file or object, e.g., text included in the web site document, etc., may be parsed in an effort to identify key words, frequently occurring phrases, etc. Depending on the amount of contextual data desired, more or less of the file may be utilized, e.g., just the text of the URL, just the title of the web page, all the contents of the web page, etc.

Similarly, text that has been received from someone else may be included in the contextual data accessed at 303. For example, a word or phrase from an ongoing message string may be weighted higher than a standard dictionary word or words in processing the user input. By way of specific example, if someone just sent the user a text message include the phrase “Coach Smith” and the user input at 301 is “Sm”, where “Sm” is a partial input, an embodiment may auto-complete to or suggest “Smith” rather than “Smart” or some other basic dictionary or prior input based result.

The contextual data may include timing data as well. For example, an embodiment chooses appropriate contextual data based on how recent the additional qualifiers were introduced into the contextual data store. By way of specific example, if the last picture a user took with his or her device was of a car, but the user took a picture of a plant or a flower last week, then words related to “car” may be weighted higher than those related to “flower” or “plant.” Thus, the input method helps complete or correct words using timing information as well.

If contextual data is available, as illustrated at 304, an embodiment may then identify one or more words within the user input based on the contextual data, as illustrated at 305. Naturally, if no contextual data is available, or if access to contextual data is not helpful, standard or conventional techniques may be employed, as illustrated in FIG. 3.

In an embodiment, a current context may be determined based on the contextual data, which then shifts or adjusts the input processing. For example, while a user input is provided at 301, an embodiment may determine, e.g., by accessing recent (e.g., near real time) location data, for example recently added to a contextual data store, that a user is at a particular location. Thus, an embodiment may attempt to access certain contextual data based on the current context, e.g., prior to accessing other contextual data or instead of accessing other contextual data. By way of example, if a user is in a determinable location, and a location based service offers data related to that determinable location, an embodiment may first or exclusively access this contextual data rather than other available contextual data, e.g., contextual data derived from prior communications with a device contact, e.g., that are a week or a month old. Thus, the contextual data accessed is chosen based on the current context of the user input. There are other possibilities in addition to location for determining a current context. For example, an application that is currently open on the electronic device during the user input may influence the determining of the current context and thus the choice of which contextual data to access.

An embodiment therefore improves user input methods by taking into account the rich contextual data that is available. This contextual data may be accessed and used to adjust a word identification, a word correction or a word prediction that would have resulted using conventional techniques, e.g., access to prior user inputs and a basic dictionary look up. An embodiment therefore increases the ease of use, speed and accuracy with which a user may input data into the electronic device.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.”Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, electromagnetic, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a magnetic storage device, or any suitable combination of the foregoing. In the context of this document, a storage device is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at an input device of an electronic device, a user input;
accessing, using a processor, prior user inputs to the input device;
accessing, using a processor, contextual data; and
identifying, using a processor, one or more words within the user input based on the contextual data.

2. The method of claim 1, wherein the contextual data is data selected from the group consisting of data derived from an image, data derived from a location based resource, and data derived from a communication application.

3. The method of claim 2, further comprising processing application data to create the contextual data.

4. The method of claim 3, wherein the application data comprises metadata associated with an application file.

5. The method of claim 1, wherein the identifying comprises adjusting the ranking of a word identification result based on the contextual data.

6. The method of claim 1, further comprising determining a current context;
wherein the contextual data accessed is chosen based on the current context.

7. The method of claim 6, wherein the determining comprises determining at least one application is currently open on the electronic device.

8. The method of claim 6, wherein the determining comprises determining a current location of the device.

9. The method of claim 1, wherein the user input is selected from the group of audio input and text input.

10. The method of claim 1, further comprising displaying the one or more words as suggested input.

11. An electronic device, comprising:
an input device;
a processor operatively coupled to the input device; and
a memory device comprising instructions executable by the processor to:
receive, at the input device, a user input;
access prior user inputs to the input device;
access contextual data; and
identify one or more words within the user input based on the contextual data.

12. The electronic device of claim 11, wherein the contextual data is data selected from the group consisting of data derived from an image, data derived from a location based resource, and data derived from a communication application.

13. The electronic device of claim 12, wherein the instructions are further executable by the processor to process application data to create the contextual data.

14. The electronic device of claim 13, wherein the application data comprises metadata associated with an application file.

15. The electronic device of claim 11, wherein to identify comprises adjusting the ranking of a word identification result based on the contextual data.

16. The electronic device of claim 11, further wherein the instructions are further executable by the processor to determine a current context;
wherein the contextual data accessed is chosen based on the current context.

17. The electronic device of claim 16, wherein to determine comprises determining at least one application is currently open on the electronic device.

18. The electronic device of claim 16, wherein to determine comprises determining a current location of the device.

19. The electronic device of claim 11, wherein the user input is selected from the group of audio input and text input.

20. A product, comprising:
a storage device having code stored therewith, the code being executable by a processor and comprising:
code that receives a user input;
code that accesses prior user inputs to the input device;
code that accesses contextual data; and
code that identifies one or more words within the user input based on the contextual data.
